(19) United States
(12) Patent Application Publication
(10) Pub. No.: US 2003/0193146 A1
(43) Pub. Date: Oct. 16, 2003

(54) Brush seal with reduced clearance

(76) Inventor: Mark E. Addis, Kennebunk, ME (US)

Correspondence Address: PRATT & WHITNEY, 400 MAIN STREET, MAIL STOP: 132-13, EAST HARTFORD, CT, 06108, US

(21) Appl. No.: 10/119,498

(22) Filed: Apr. 10, 2002

(51) Int. Cl. F16J 15/44

(52) U.S. Cl. 277/355

(57) ABSTRACT

A brush seal, comprising: a side plate; a back plate; and a bristle arrangement between the side plate and back plate. At least a portion of the back plate is made from a material that tends not to burr when contacting a rotating component. The bristle arrangement could include a plurality of bristles secured together by a joint. The entire back plate could be made from the low coefficient of friction or low wear rate material. In addition, the side plate could also be made from the low coefficient of friction or low wear rate material. The material allows a reduced clearance between the brush seal and the component engaged by the brush seal.

### CROSS REFERENCE TO RELATED APPLICATIONS

This application is related to a U.S. patent application Ser. No. (not yet assigned, but Attorney Docket Number EH-10586) filed on Feb. 12, 2002, herein incorporated by reference.

### BACKGROUND OF THE INVENTION

This invention relates to brush seals. Specifically, the invention relates to brush seals that have reduced clearances.

A brush seal includes a side plate, a back plate and bristles between the plates. Gas turbine engines commonly use brush seals to prevent secondary flow from escaping through a gap between a stationary part (e.g. a diffuser case) and a rotating part (e.g. a turbine shaft). In this arrangement, the bristles of the brush seal impede the ability of the secondary flow to pass between the stationary and rotating parts. The bristles impede the secondary flow by extending from the stationary part, into the gap, and into contact with the rotating part.

The back plate of the brush seal remains a distance away from the rotating part. The size of the clearance between the back plate and the rotating part directly affects the efficiency of the brush seal. A brush seal with a larger back plate clearance allows a greater amount of secondary flow to pass through the bristles. A brush seal with a smaller back plate clearance allows a lesser amount of secondary flow to pass through the bristles.

Conventional brush seals tend to have larger clearances. While less efficient, these larger clearances help the brush seal to avoid contact between the back plate and the rotating component during operation of the engine. Contact between the metallic back plate of a conventional brush seal and the metallic rotating component can damage the brush seal. For example, such contact between the brush seal and the rotating component can wear away the back plate. Wearing away the back plate increases the clearance between the brush seal and the rotating component.

Such contact between the metallic back plate and rotating component can also form burrs on the back plate. Any burrs present on the back plate could nick or cut the adjacently located bristles. Depending on the severity of damage to the bristles, the entire bristle pack could fail.

One solution to this problem has been to allow the brush seal to float between the stationary component and the rotating component. The use of a floating brush seal, however, increases the complexity and part count of the brush seal assembly.

### BRIEF SUMMARY OF THE INVENTION

It is an object of the present invention to provide a new and improved brush seal.

It is a further object of the present invention to provide a more efficient brush seal.

It is a further object of the present invention to provide a brush seal that can be placed at a reduced clearance with the rotating component.

It is a further object of the present invention to provide a brush seal that exhibits less wear after contact with the rotating component.

It is a further object of the present invention to provide a brush seal that exhibits less damage after contact with the rotating component.

It is a further object of the present invention to provide a brush seal that is not complex.

It is a further object of the present invention to provide a brush seal that does not have a high part count.

These and other objects of the present invention are achieved in one aspect by a brush seal, comprising: a side plate; a back plate; and a bristle arrangement between the side plate and back plate. At least a portion of the back plate is made from a material that tends not to burr when contacting a rotating component.

These and other objects of the present invention are achieved in another aspect by a brush seal, comprising: a side plate; a back plate; and a bristle arrangement between the side plate and back plate. The bristle arrangement includes a plurality of bristles secured together by a joint. At least the back plate is made from a low coefficient of friction or low wear rate material.

These and other objects of the present invention are achieved in another aspect by a brush seal, comprising: a side plate; a back plate; and a plurality of bristles between the plates. The bristles are metallic and at least one of the plates is plastic.

These and other objects of the present invention are achieved in another aspect by a method of reducing a clearance between a brush seal and a component. The method comprises the steps of: providing a brush seal having a back plate and bristles; forming at least a portion of the back plate from a material that resists burring when contacting a rotating component; and spacing the portion from said component at a reduced distance. The reduced distance is less than a distance if the portion was not made from the low coefficient of friction or low wear rate material.

### BRIEF DESCRIPTION OF THE DRAWINGS

Other uses and advantages of the present invention will become apparent to those skilled in the art upon reference to the specification and the drawings, in which:

FIG. 1 is a cross-sectional perspective view of a conventional brush seal engaging a rotor;

FIG. 2 is a cross-sectional perspective view of a brush seal of the present invention;

FIG. 3a is a detailed view of a section of the brush seal in FIG. 2;

FIG. 3b is a detailed view of an alternative arrangement of the section in FIG. 3a;

FIG. 4 is a cross-sectional perspective view of another alternative embodiment of a brush seal of the present invention;

FIG. 5 is a cross-sectional perspective view of another alternative embodiment of a brush seal of the present invention; and

FIG. 6 is a side-by-side comparison of the conventional brush seal in FIG. 1 and the brush seal of the present invention in FIG. 2.

### DETAILED DESCRIPTION OF THE INVENTION

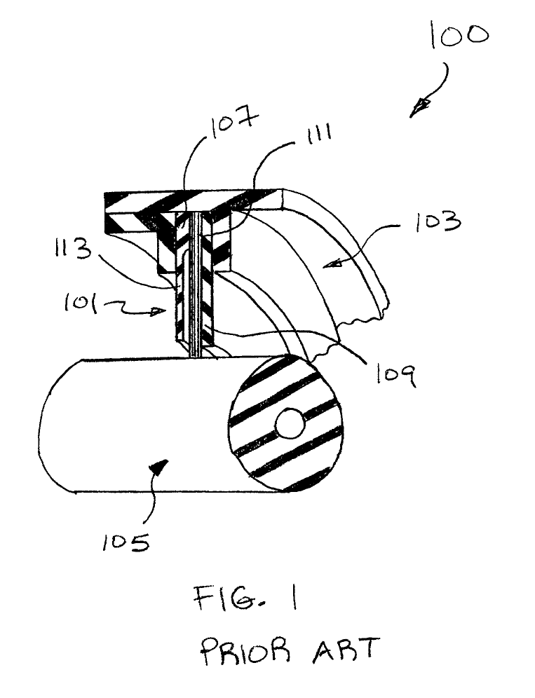

FIG. 1 displays a conventional brush seal arrangement 100. The arrangement 100 includes a brush seal 101 rigidly secured to a first component 103 (typically a stationary component of the engine). The brush seal 101 extends from the first component 103 to engage a second component 105 (typically a rotating component of the engine).

The brush seal 101 includes a side plate 107, a back plate 109 and a bristle pack 111 between the plates 107, 109. The plates 107, 109 are made from suitable alloys, such as Inconel® or 400-series stainless steel. The side plate 107 can include a windage cover 113. Typically, the plates 107, 109 and the bristle pack 111 are welded together.

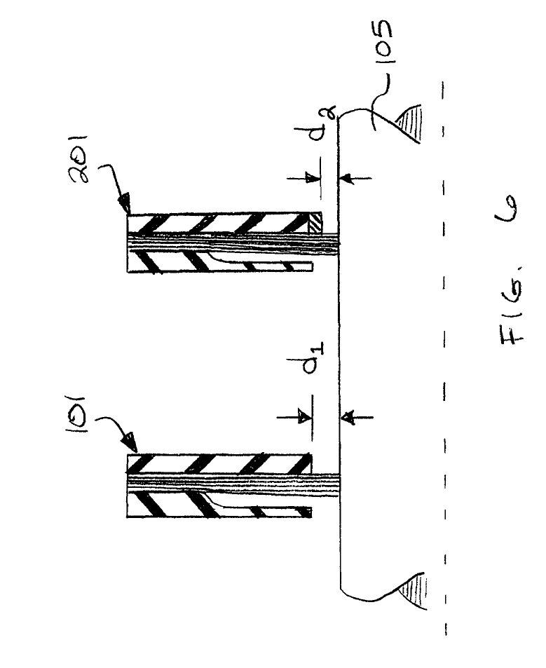

As seen in FIG. 6, the back plate 109 of the brush seal 101 remains a distance d₁, from the second component 105. The distance d₁, is sufficient to ensure that the metallic back plate 109 tends to avoid contact with the metallic second component 105. As described above, avoiding contact between the back plate 109 and the second component 105 helps prevent damage to the brush seal 101.

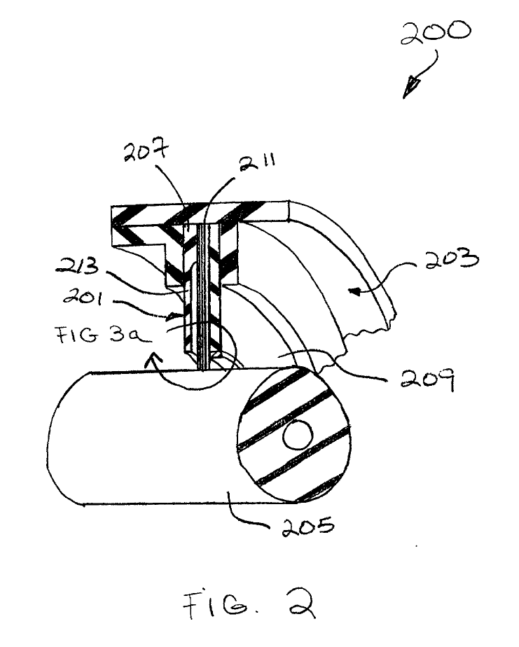

FIG. 2 displays one embodiment of a brush seal arrangement 200 of the present invention. The arrangement likewise includes a brush seal 201 rigidly secured to a first component 203. The brush seal 201 extends from the first component 203 to engage a second component 205.

Similar to the conventional brush seal 101, the brush seal 201 includes a side plate 207, a back plate 209 and a bristle pack 211 between the plates 207, 209. The side plate 207 can include a windage cover 213. The plates 107, 109 and the bristle pack 111 can be secured together using suitable techniques such as welding.

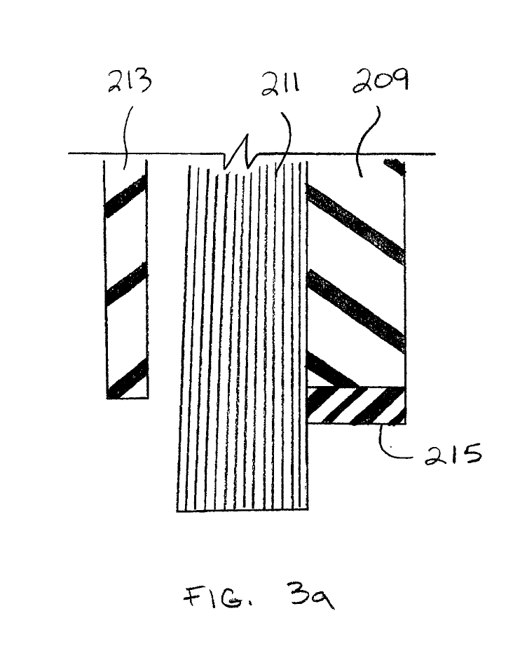

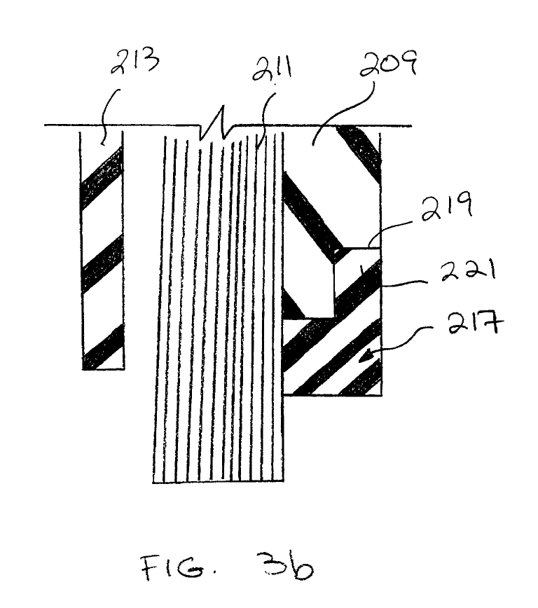

FIG. 3a displays a detailed view of the distal end of the brush seal 201. In the arrangement shown in the figures, the distal end of the brush seal 201 is the inner diameter of the annular brush seal 201. The inner face of the back plate 209 has a coating 215 placed thereon using known techniques. Preferably, application of the coating 215 on the back plate occurs before assembly of the brush seal 201.

The coating 215 should be a material that tends not to produce burrs during contact with the rotating component. The coating 215 should also have capability to withstand the elevated temperatures encountered in the secondary flow of the engine. A suitable coating 215 could have a low coefficient of friction and/or a low wear rate. For example, the coating 215 could be a fluoropolymer such as PTFE. Alternatively, the coating 215 could be an abradable metal.

FIG. 3b displays a detailed view of an alternate embodiment of the distal end of the brush seal 201. Rather than the coating 215 of FIG. 3a, the back plate 209 has an insert 217 secured thereto using known techniques. Depending upon the insert material, such techniques could include epoxy bonding or brazing. The back plate 209 could include a shoulder 219 to receive a correspondingly shaped extension 221 from the insert 217. Preferably, bonding the insert 217 to the back plate occurs before assembly of the brush seal 201.

The insert 217 should likewise be a material that resists burrs during contact between the back plate 209 and the rotating component. The insert 217 should also have capability to withstand the elevated temperatures encountered in the secondary flow of the engine. As discussed above, a fluoropolymer like PTFE could be used. In addition, the insert 217 could also be made from carbon, graphite or sintered impregnated metal matrix materials.

The alternative embodiments described above are preferably used with brush seals having the typical bristle arrangement shown in FIG. 2. The alternative embodiments described below are preferably used with brush seals having the bristle arrangement described in U.S. patent application Ser. No. (not yet assigned, but Attorney Docket Number EH-10586) filed on Feb. 12, 2002.

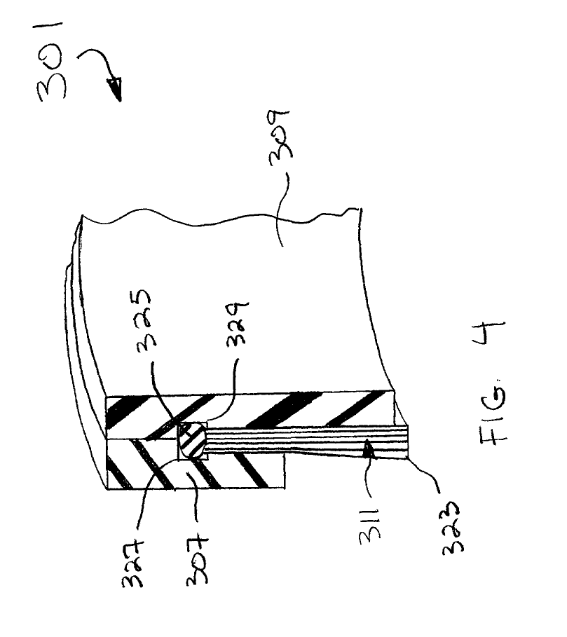

FIG. 4 shows another alternative embodiment of a brush seal 301 of the present invention. The brush seal 301 rigidly secures to a first component (not shown) and engages a second component (not shown).

The brush seal 301 includes a side plate 307, a back plate 309 and a bristle pack 311 between the plates 307, 309. The annular bristle pack 311 (also referred to as a bristle ring) includes a plurality of bristles 323 secured together by a joint 325. The joint 325 forms while welding the alloy bristles 323 (such as cobalt) together during an earlier assembly step.

The plates 307, 309 each include a groove 327, 329 to receive the joint 325. The grooves 327, 329 preferably prevent radial movement of the bristle pack 311 during engine operation without creating an interference fit. Differently than the earlier embodiments, the back plate 309 is made entirely from the aforementioned materials. For example, the back plate 309 could be made entirely from a suitable low coefficient of friction or low wear rate material. The back plate 309 could be made from these materials using known techniques such as injection molding, machining or extruding.

The plates 307, 309 secure together using suitable techniques such as epoxy or braze bonding or using rivets (not shown) or threaded fasteners (not shown). The metallic side plate 307 helps provide rigidity to the brush seal 301. If rigidity is not a concern, then the side plate 307 could also be made from the aforementioned materials. For example, the side plate 307 could also be made from a low coefficient of friction or low wear rate material. Preferably, the side plate 307 would be made from the same material as the back plate 309.

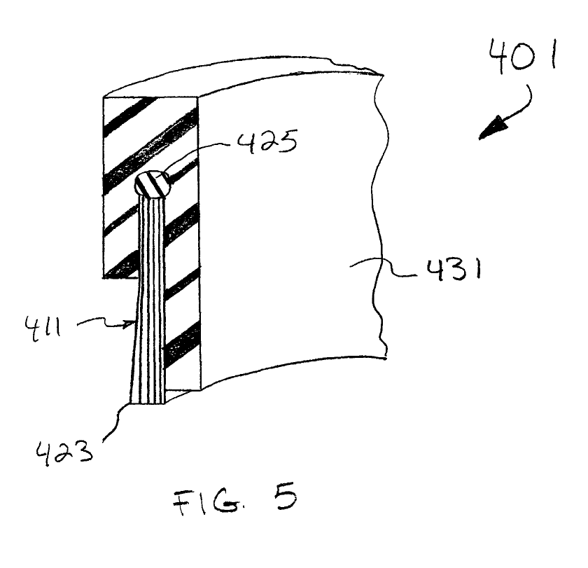

FIG. 5 shows another alternative embodiment of a brush seal 401 of the present invention. The brush seal 401 has a one-piece body 431 rather than the discrete side plates and back plates of the earlier embodiments. The brush seal 401 also includes an annular bristle pack 411 with bristles 423 secured together by a joint 425. The body 431 retains the joint 425 and a section of the bristles 423.

The body 431 is preferably made from the aforementioned materials. For example, the side plate 307 could be made from a low coefficient of friction or low wear rate material. Preferably, the body 431 is plastic and is overmolded about the bristle pack 411 using known techniques. Other methods of forming the brush seal 401 could be used.

FIG. 6 displays the benefits of the present invention. Using suitable materials, the brush seal 201 of the present invention can position the back plate at a distance d₂ from the second component 105. The distance d₂ of the present invention is less than the distance d₁, of conventional brush seals with all-metallic back plates. The distance d₂ could be approximately 10-25% less than the distance d₁, of conventional brush seals.

The reduced clearance exhibited by the brush seal of the present invention helps increase efficiency. The efficiency of the brush seal increases as the gap between the brush seal and the rotating component decreases. A smaller gap impedes the ability of the secondary flow to pass between the stationary and rotating parts.

The reduced clearance of the present invention also helps prevent bristle blowover. Blowover occurs when the secondary flow begins to urge the bristles in the flow direction. The bristles tend to wrap under the back plate. Such bending of the bristles introduces stresses to the bristles.

Since the present invention has a reduced clearance, shorter lengths of the bristles extend in cantilever fashion from the back plate. In other words, the back plate of the present invention supports a greater length of the bristles. This support helps the bristles withstand the urging of the secondary flow. As a result, the bristles tend to exhibit less stress.

Even with this reduced clearance, the present invention does not exhibit the damage encountered by conventional brush seals during contact with the rotating component. The aforementioned materials, such as a low coefficient of friction or low wear rate material, does not form burrs during such contact. Lacking burrs, the back plate does not nick or cut the bristles. With intact bristles, the efficiency of the brush seal tends not to degrade after contact between the back plate and the rotating component.

The present invention has been described in connection with the preferred embodiments of the various figures. It is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A brush seal, comprising:
a side plate;
a back plate; and
a bristle arrangement between said side plate and said back plate;
wherein at least a portion of said back plate is made from a material tends not to burr when contacting a rotating component.

2. The brush seal as recited in claim 1, wherein said material is a coating and said portion is an inner face.

3. The brush seal as recited in claim 1, wherein said portion is an insert secured to an inner diameter of said back plate.

4. The brush seal as recited in claim 1, wherein all of said back plate is made from said material.

5. The brush seal as recited in claim 4, wherein said side plate is also made from said material.

6. The brush seal as recited in claim 1, wherein said side plate and said back plate are one-piece.

7. The brush seal as recited in claim 1, wherein said bristle arrangement comprises a bristle ring.

8. The brush seal as recited in claim 7, wherein all of said back plate is made from said material.

9. The brush seal as recited in claim 7, wherein said side plate and said back plate are overmolded about said bristle ring.

10. A brush seal, comprising:
a side plate;
a back plate; and
a bristle arrangement between said side plate and said back plate, said arrangement including a plurality of bristles secured together by a joint;
wherein at least said back plate is made from a low coefficient of friction or low wear rate material.

11. The brush seal as recited in claim 10, wherein said side plate is also made from said material.

12. A brush seal, comprising:
a side plate;
a back plate; and
a plurality of bristles between said side plate and said back plate;
wherein said bristles are metallic and at least one of said plates is plastic.

13. The brush seal as recited in claim 12, wherein both of said plates are plastic.

14. A method of reducing a clearance between a brush seal and a component, comprising the steps of:
providing a brush seal having a back plate and bristles;
forming at least a portion of said back plate from a material that resists burring when contacting a rotating component; and
spacing said portion from said component at a reduced distance;
wherein said reduced distance is less than a distance if said portion were not made from said material.

15. The method as recited in claim 14, wherein said reduced distance is at least approximately 10% less than said distance.

16. The method as recited in claim 14, wherein said forming step comprises coating an inner face of said back plate with said material.

17. The method as recited in claim 14, wherein said forming step comprises securing an insert to an inner diameter of said back plate.

18. The method as recited in claim 14, wherein said forming step forms all of said back plate from said material.

19. The method as recited in claim 18, wherein said brush seal includes a side plate, and said forming step includes forming said side plate from said material.

20. The method as recited in claim 14, wherein said brush seal includes a side plate, said side plate and said back plate being one-piece.

21. The method as recited in claim 14, wherein said bristles comprises a bristle ring.

22. The method as recited in claim 21, wherein said forming step forms all of said back plate from said material.

23. The method as recited in claim 21, wherein said brush seal includes a side plate, and said forming step overmolds said side plate and back plate about said bristle ring.
